(19) United States
(12) Patent Application Publication
(10) Pub. No.: US 2011/0116980 A1
(43) Pub. Date: May 19, 2011

(54) PREFERENTIAL OXIDATION REACTOR

(75) Inventors: Jin-Goo AHN, Suwon-si (KR); Woo-Cheol Shin, Suwon-si (KR); In-Hyuk Son, Suwon-si (KR); Jong-Rock Choi, Suwon-si (KR); In-Seob Song, Suwon-si (KR)

(73) Assignee: Samsung SDI Co., Ltd., Suwon-si (KR)

(21) Appl. No.: 12/756,848

(22) Filed: Apr. 8, 2010

(30) Foreign Application Priority Data
Nov. 17, 2009 (KR) 10-2009-0110773

(51) Int. Cl. B01D 53/62

(52) U.S. Cl. 422/171

(57) ABSTRACT

There is provided a preferential oxidation reactor having excellent carbon monoxide reducing performance while providing for self-ignition of mixed hydrogen gas. The preferential oxidation reactor includes: a first reaction unit including a first internal space connected with a first opening portion and a first catalyst capable of spontaneously igniting hydrogen mixed gas at a predetermined atmospheric temperature of the first internal space; a second reaction unit including a second internal space connected to a second opening portion and a second catalyst contained in the second internal space; and a separation layer that is positioned between the first and second catalysts so as to separate the first catalyst and the second catalyst from each other and which connects the first internal space and the second internal space to each other to be in fluid communication.

### CROSS-REFERENCE TO RELATED APPLICATIONS

This application claims priority to and the benefit of Korean Patent Application No. 10-2009-0110773, filed on Nov. 17, 2009, in the Korean Intellectual Property Office, the entire content of which is incorporated herein by reference.

### BACKGROUND OF THE INVENTION

1. Field of the invention

An embodiment of the present invention relates to a preferential oxidation reactor having excellent carbon monoxide reduction performance while providing for self-ignition of the reformate.

2. Discussion of Related Art

In modern society, because concern about environmental pollution is increasing, the development of alternative energy sources such as fuel cells which are non-pollutive and excellent in energy efficiency, etc. is in active progress.

Protons used as fuel for a fuel cell are typically acquired from reformate, i.e., reforming ethanol, methanol, liquefied petroleum gas (LPG), gasoline, etc., due to the various difficult problems caused by storage and transportation of hydrogen. The reformate acquired in the reforming process contains carbon dioxide, carbon monoxide, etc., in addition to protons. Carbon monoxide deteriorates electrode activation by poisoning electrode active materials of a polyelectroytic fuel cell, e.g., platinum (Pt). Accordingly, in order to use the reformate, carbon monoxide contained in the reformate needs to be reduced to 10 ppm or less.

A method for removing carbon monoxide from the reformate includes a method using palladium (Pd) or a palladium alloy membrane, a method using methanation or preferential oxidation or selective oxidation, etc.

### SUMMARY OF THE INVENTION

An embodiment of the present invention provides a preferential oxidation reactor which can reduce carbon monoxide in reformate (hereinafter, referred to as hydrogen mixed gas) to 10 ppm or less, while providing for self-ignition of the reformate.

According to an embodiment of the present invention, a preferential oxidation reactor includes: a first reaction unit including a first internal space connected with a first opening portion and a first catalyst, capable of spontaneously igniting hydrogen mixed gas at a predetermined atmospheric temperature of the first internal space; a second reaction unit including a second internal space connected to a second opening portion and a second catalyst contained in the second internal space; and a separation layer that is positioned between the first and second catalysts so as to separate the first catalyst and the second catalyst from each other, and which connects the first internal space and the second internal space to each other to be in fluid communication.

In the embodiment, the entire volume of the first catalyst is 0.004 times or more of the flow rate per minute of hydrogen mixed gas supplied to the first internal space.

In the embodiment, the first catalyst includes transition metal. The first catalyst may contain platinum or one selected from palladium (Pd), rhenium (Re), rhodium (Rh), cerium (Ce), ruthenium (Ru), and iridium (Ir) or a combination thereof in addition to platinum (Pt).

In the embodiment, the first catalyst contains a ceramic carrier, a metallic carrier, or a carbon carrier that have a granule shape, or a combination thereof.

In the embodiment, the second catalyst includes a granule-type carrier.

In the embodiment, the size of each of the granule-type second catalysts is larger than the size of each of the granule-type first catalysts.

In the embodiment, the second catalyst includes non-metal. The second catalyst may contain copper (Cu), iron (Fe), cobalt (Co), cerium (Ce), aluminum (Al), or one selected from an oxide thereof, or a combination thereof.

In the embodiment, the first catalyst contains a ceramic carrier, a metallic carrier, or a carbon carrier that have a granule shape, or a combination thereof.

In the embodiment, the entire volume of the first catalyst is smaller than the entire volume of the second catalyst.

In the embodiment, the separation layer includes a porous plate member.

In the embodiment, the second reaction unit is positioned lower than the first reaction unit in the direction of gravitational force field lines.

In the embodiment, the preferential oxidation reactor further includes a water receiving unit lower than the first reaction unit in the gravitational force line direction.

In the embodiment, the second opening portion is positioned in an upper part of the water receiving unit in the direction of gravitational force field lines.

In the embodiment, the preferential oxidation reactor includes a pipe-type discharge unit that: connects the water receiving unit and the second opening portion to each other to be in fluid communication.

In the embodiment, the first reaction unit, the second reaction unit, and the discharge unit have a dual-pipe structure.

According to the embodiments, it is possible to reduce the concentration of carbon monoxide in hydrogen mixed gas to several ppm in a normal state while providing for self-ignition of the hydrogen mixed gas. Further, by separately arranging two kinds of catalysts having different sizes in a predetermined order, the pressure in the reactor is increased only a little. Therefore, to address an increase in pressure caused by using two mixed catalysts, an additional device, i.e., a pressurizing means, such as a pump, etc., does not need to be additionally installed. That is, it is possible to provide a preferential oxidation reactor having excellent performance with self-ignition of the hydrogen mixed gas. Moreover, since an igniter may be omitted, it is possible to achieve miniaturization of the device.

### BRIEF DESCRIPTION OF THE DRAWINGS

The accompanying drawings, together with the specification illustrate exemplary embodiments of the present invention, and, together with the description, serve to explain the principles of the present invention.

FIG. 1 is a schematic block diagram of a fuel cell system having a preferential oxidation reactor according to an embodiment.

FIG. 2 is a schematic cross-sectional view of a preferential oxidation reactor according to an embodiment.

FIG. 3 is a schematic cross-sectional view of a preferential oxidation reactor according to another embodiment.

FIG. 4 is a schematic cross-sectional view for describing a preferential oxidation reactor according to a comparative example.

FIG. 5 is a schematic cross-sectional view for describing a preferential oxidation reactor according to another comparative example.

FIG. 6 provides Table 1 which shows the results of measurements of the content of carbon monoxide in hydrogen mixed gas discharge from a PROX device.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. in addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

In describing the embodiment, well-known functions or constructions will not be described in detail since they may unnecessarily obscure the understanding of the present invention. In addition, it will be appreciated that like reference numerals refer to like elements throughout even though they are shown in different figures. Further, when a first element is described as being coupled to a second element, the first element may be not only directly coupled to the second element but may also be indirectly coupled to the second element via a third element. Moreover, when a first layer is provided on a second layer, the first layer may he provided directly on the second layer or a third layer may be interposed therebetween. Besides, in the figures, the thickness and sizes of each layer may be exaggerated for convenience of description and clarity and may be different from the actual thickness and size.

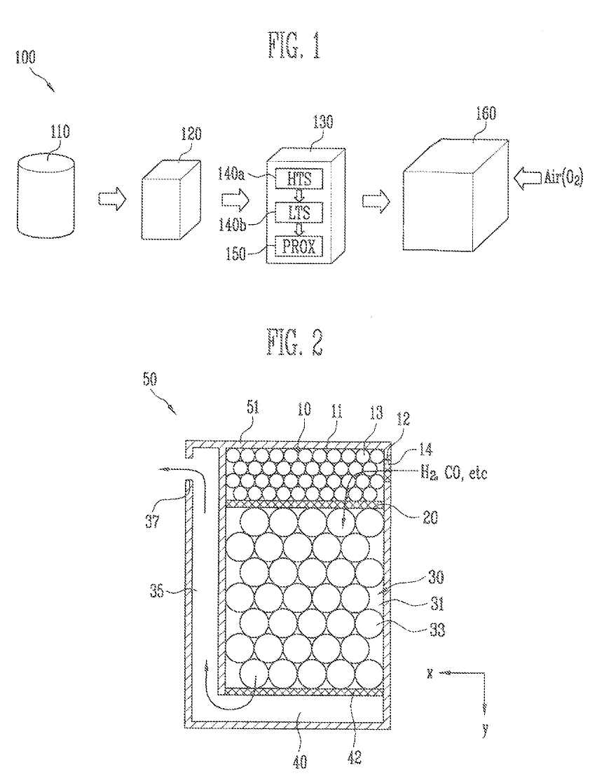

FIG. 1 is a schematic block diagram of a fuel cell system having a preferential oxidation reactor according to an embodiment

Referring to FIG. I, the fuel cell system 100 includes a fuel storage device 110, a fuel reformer 120, a carbon monoxide reducer 130, and a fuel cell 160. The carbon monoxide reducer 130 includes a high-temperature water-gas shift reaction unit 140a, a low-temperature water-gas shift reaction unit 140b, and a preferential oxidation reaction unit 150. Air and/or water may be suitably supplied to each reactor or reaction unit. The fuel cell 160 generates electricity and water by electrochemical reaction of hydrogen in hydrogen mixed gas and oxygen in air received from the preferential oxidation reaction unit 150. The generated water may be reutilized.

Each component will be described in more detail below. The fuel storage device 110 may include a fuel tank coupled with another fuel tank or a fuel pump. Methanol, liquid natural gas (LNG), liquid petroleum gas (LPG), gasoline, diesel, etc. may be used as fuel.

The reformer 120 generates reformate (hydrogen mixed gas) by reforming the fuel. The hydrogen mixed gas generated from the fuel reformer 120 contains carbon monoxide at approximately 10 to 13%. As a reforming method, a steam reforming method and/or a partial oxidation method may be used.

The water-gas shift reaction units 140a and 140b receive the hydrogen mixed gas from the fuel reformer 120 and decrease the content of carbon monoxide in the hydrogen mixed gas to approximately 0.5 to 1%. The water-gas shill reaction may be divided into a high-temperature water-gas shift reaction in which the concentration of carbon monoxide is decreased to approximately 4% at approximately 400° C. and a low-temperature water-gas shift reaction in which the concentration of carbon monoxide is decreased to approximately 0.5 to 1% at approximately 200° C. as a first step.

The preferential oxidation reaction unit ISO receives the hydrogen mixed gas from the water-gas shift reaction unit 140b and decreases the content of carbon monoxide in the hydrogen mixed gas to 10 ppm or below. In the preferential oxidation reaction, only carbon monoxide in the hydrogen mixed gas is selectively removed by injecting a predetermined amount of air in the reaction unit. The preferential oxidation reaction preferentially oxidizes and removes only carbon monoxide to 0.5 to 1% in the hydrogen mixed gas in which hydrogen of approximately 65 to 75% exists. The preferential oxidation reaction unit 150 of the embodiment may be designed on the basis of the preferential oxidation reactor to be described below.

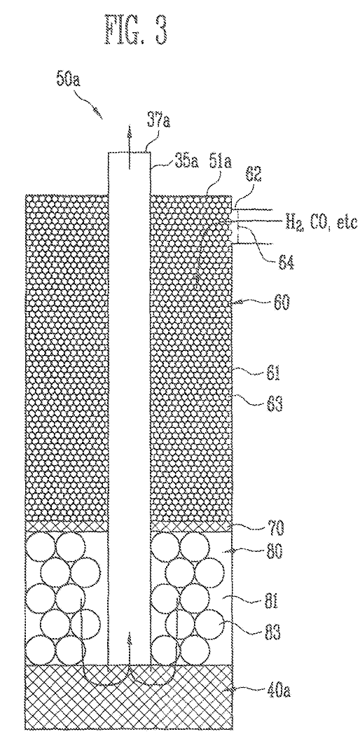

FIG. 2 is a schematic cross-sectional view of a preferential oxidation reactor according to an embodiment.

Referring to FIG, 2, the preferential oxidation reactor 50 (hereinafter, referred to as PROX device) includes a first reaction unit 10, a separation layer 20, and a second reaction unit 30. Further, the PROX device 50 may selectively include a discharge unit 35 and a water receiving unit 40.

In the embodiment, the separation layer 20 is interposed between the first and second reaction units 10 and 30 in a single internal space of a housing 11 and the first and second reaction units 10 and 30 are disposed at both sides of the separation layer 20. The separation layer 20 is provided in an inner space of the housing to prevent a first catalyst 13 having a granule shape and a second catalyst 33 having a granule shape from being mixed. Hereinafter, spaces where the first catalyst 13 and the second catalyst 33 are positioned, which are portioned by the separation layer 20 in the internal space of the housing 11 are referred to as a first internal space 11 and a second internal space 31.

It is relatively simple to manufacture the reactor by using the first catalyst 13 having a granule shape and the second catalyst 33 having a granule shape. That is, when the first and second catalysts 13 and 33 having a granule shape are just filled in a predetermined position in the inner space of the housing 11, manufacture of the reactor is substantially completed.

A first opening portion 12 is provided at one side of the first internal space 11. The hydrogen mixed gas containing hydrogen and carbon monoxide are introduced into the first opening portion 12 under predetermined pressure. A suitable component 14 for preventing the first catalyst 13 having a granule shape from being dispersed may be provided in the first opening portion 12. The component 14 may be a component having a mesh shape.

The first catalyst 13 is, of itself, heated by reaction of the hydrogen mixed gas and a predetermined amount of air (not shown) that are introduced into the first internal space 11. In addition, the first catalyst 13 reaches temperature required for the reaction to be self-ignited. Thermal energy of the first catalyst 13 heats the hydrogen mixed gas and the housing 11. That is, the second catalyst 33 is heated by the thermal energy of the first catalyst 13. A platinum-based catalyst is used as the first catalyst 13.

The separation layer 20 includes a plurality of channels through which the hydrogen mixed gas passing through the First internal space 11 passes. In the separation layer 20, the size of the opening portion at a channel inlet adjacent to the first catalyst 13 is smaller than the size of a predetermined cross section of the first catalyst 13. This is to prevent the first catalyst 13 from moving to the second internal space 33 through the separation layer 20. Further, this is to prevent the first catalyst 13 from plugging the channel inlet of the separation layer 20. A metallic porous plate member may be used as the separation layer 20.

The hydrogen mixed gas flows into the second internal space 31 through the separation layer 20 in the first internal space 11. The second catalyst 33 heated by the first catalyst 13 is provided in the second internal space 31.

A non-metal catalyst is used as the second catalyst 33. When the non-metal catalyst is primarily used as the PROX device 50, it is possible to decrease the manufacturing cost of the reactor. Further, a non-metal catalyst may decrease the content of carbon monoxide in the hydrogen mixed gas to several ppm. Meanwhile, generally, a non-metal catalyst is not self-ignited by reaction of the hydrogen mixed gas and a predetermined amount of air. However, according to the embodiment, even though a non-metal catalyst is used as the second catalyst 33, the second catalyst 33 is heated by the first catalyst 13 to be ignited at a temperature required for reaction.

The hydrogen mixed gas has a content of carbon monoxide that is decreased to several ppm by the first and second catalysts 13 and 33 and is discharged through a second opening portion 37 connected to the second internal space 31.

As described above, in the embodiment, it is possible to easily provide a small-sized, high-performance PROX device which can decrease the content of carbon monoxide in the hydrogen mixed gas while providing for self-ignition, by separately installing the platinum-based first catalyst 13 and the non-metal-based second catalyst 33 in the internal space of the single housing 11 with the separation layer 20 interposed therebetween.

Additionally, in the PROX device 50, the second reaction unit. 30 is configured to be positioned lower than the first reaction unit 10. Herein, “lower” corresponds to a lower position based on substantially the direction of gravitational field lines or, in other words, a y-axis direction. A structure in which the second reaction unit 30 is positioned lower than the first reaction unit 10 effectively performs the function of supplying hydrogen-containing gas under predetermined internal pressure. Further, such a structure allows water generated when the PROX device 50 starts or stops to be normally discharged.

Further, the PROX device 50 of the embodiment may have the water receiving unit 40 lower than the second reaction unit 30. The water receiving unit 40 may be provided in a predetermined space lower than the second reaction unit 30. In this case, a partition 42 having at least one opening portion may be provided between the second reaction unit 30 and the water receiving unit 40. The partition 42 may have a structure and a shape in which the hydrogen mixed gas in the second reaction unit 30 can easily pass through the partition 42. The partition 42 may have a structure and a shape similar to the separation layer 20.

Further, the PROX device 50 of the embodiment may have a pipe-type discharge unit 35 which connects the water receiving unit 40 and the second opening portion 37 to each other to he in fluid communication. The discharge unit 35 serves to guide the hydrogen mixed gas discharged through at least one opening portion of the partition 42 to a second opening portion 27 in an upper part of the housing 11 or in an upper part of the water receiving unit 40. One end of the discharge unit 35 may be connected to the water receiving unit 40 to be in fluid communication. The discharge unit 35 can be modified into various structures and shapes having a channel through which fluid can flow in addition to the pipe shape.

FIG. 3 is a schematic cross-sectional view of a preferential oxidation reactor according to another embodiment.

Referring to FIG. 3, the PROX device 50a of the embodiment includes a first reaction unit 60, a separation layer 70, and a second reaction unit 80. Further, the PROX device 50a may include a discharge unit 35a and a water receiving unit 40a.

Further, the PROX device 50a may include a dual-pipe structure formed by a housing 51a and a discharge unit 35a. That is, when the housing 51a has a cylinder structure, the pipe-type discharge unit 35a is provided to extend close to the bottom of the housing 51a crossing the center in a longitudinal direction of the housing 51a in an upper part of the housing 51a. One end portion of the discharge unit 35a is spaced from an inner surface of a bottom wall 51c of the housing 51a by a predetermined gap.

In the dual-pipe structure, a first catalyst 63, the separation layer 70, and a second catalyst 83 are sequentially laminated in an internal space formed between an outer surface of the discharge unit 35a and an inner surface of the housing 51a. Herein, a first internal space 61 of the housing 51a where the first catalyst 63 is positioned is a first reaction unit 60 and a second internal space of the housing 51a where a second catalyst 83 is positioned is a second reaction unit 80 with the separation layer 70 interposed therebetween.

Further, the dual-pipe structure, the water receiving unit 40a is provided between the inner surface of the bottom wall 51c of the housing 51a and one end portion of the discharge unit 35a. One end portion of the discharge unit 35a may be slightly inserted into the water receiving unit 40a. A porous member such as a metal foam, a ceramic foam, etc., may be used as the water receiving unit 40a.

In the embodiment, the hydrogen mixed gas is introduced into the first internal space 61 of the first reaction unit 60 through the first opening portion 62 provided in the upper part of the housing 51a. In addition, the hydrogen mixed gas flows into the second internal space 81 of the second reaction unit 80 through the separation layer 70 in the first internal space 61. Next, the hydrogen mixed gas flows via the water receiving unit 40a and the discharge unit 35a and is discharged through a second opening portion 37a. The second opening portion 37a may correspond to an opening portion of one end of the upper part of the pipe-type discharge unit 35a.

In the embodiment, the platinum-based catalyst or transition metal is used as the first catalyst 63. A catalyst in which platinum (Pt) is supported on a predetermined carrier may be used as the first catalyst 63. further, a bi-functional catalyst or a three way catalyst which includes palladium (Pd), rhenium (Re), rhodium (Rh), cerium (Ce), ruthenium (Ru), or iridium (Ir), or a combination thereof, and platinum, are supported on a predetermined carrier may be used as the first catalyst 63.

The non-metal catalyst is used as the second catalyst 83. Copper (Cu), iron (Fe), cobalt (Co), cerium (Ce), aluminum (Al), an oxide thereof or a combination thereof supported on a predetermined carrier, may be used as the second catalyst 83.

As the carrier of the first or second catalyst, a ceramic carrier, a metallic carrier, or a carbon carrier that have a. granule shape, or a combination thereof may be used. For example, as the carrier, aluminum oxide, cerium oxide, or a combination thereof may be used.

FIG. 6, Table 1, shows the results of measuring the content of carbon monoxide in hydrogen mixed gas discharge from the PROX device, while hydrogen mixed gas of approximately 22 liters per minute is supplied to each of the reactors of the first to eighth examples. Each of the reactors of the first to eighth examples basically corresponds to the PROX device 50a shown in FIG. 3 except for the volumes of the first and second catalysts.

In Table 1, examples displayed as “(self)” in a column representing a start time are those which are self-ignited and examples displayed as “(heater)” are those which are ignited by a heater.

In this experiment, the self-ignited examples include one experiment displayed as No. 04, four examples displayed as No. 07, and one experiment displayed as No. 08. These six examples are all self-ignited within 10 minutes. When the start time exceeds 60 minutes, it is determined that the examples are not self-ignited.

In Table 1 four examples represented as No. 07 show a slight difference in the supplied amount of air (slpm: standard liters per minute) to a burner (not shown), the supplied amount of air (seem: standard cubic centimeter per minute) to the PROX device, and the supplied amount of water to the steam reforming reactor in the fuel reforming system (see FIG. 1) having a fuel reformer and a carbon monoxide reducer and has the same reactor structure. In Table 1 reactors of four examples displayed as No. 07 have a pipe shape having a diameter (D) of 50 mm, a height/length (H) of 180 mm, and volume of 300 cc. In addition, in the column (SR water) representing the supplied amount of water to the steam reforming reactor in each example, the steam to carbon ratio (S/C: steam/carbon) is also displayed.

In Table 1, an example displayed as No. 01 has an annular reactor structure. This example (No. 01) represents a case where the second catalyst is not displayed adjacent to the lower part in the direction of gravitational field lines of the first catalyst and is not self-ignited. Example No. 03 represents a case where the volume of the first catalyst is larger than the volume of the second catalyst. In this example (No. 03), the concentration of carbon monoxide in the hydrogen mixed gas exceeds 10 ppm. Example No. 02 represents a case using only the first catalyst and in this case, although the concentration of carbon monoxide in the hydrogen mixed gas unexpectedly is less than 10 ppm, the internal pressure of the device is largely increased. Examples No. 05 and No. 06 represent cases where the volume of the first catalyst is 50 cc and 65 cc, and smaller than 80 cc, respectively. These examples (Nos. 05 and 06) are not self-ignited. One reason why the examples Nos. 05 and 06 are not self-ignited is that the volume of the first catalyst is smaller than approximately 80 cc.

As described above, in the PROX device 50a of the embodiment, the volume of the first catalyst 63 is smaller than the volume of the second catalyst 83. Moreover, it is preferable that the volume of the first catalyst 63 is equal to or larger than 80 cc.

Further, the volume of the first catalyst 63 is approximately 0.004 times the flow rate per unit time (minute) of the hydrogen containing gas supplied to the first internal space 61 through the first opening portion 62. This value is the minimum volume for self-ignition by the first catalyst 63 of the hydrogen containing gas passing through the first catalyst 63.

FIG. 4 is a schematic cross-sectional view showing a preferential oxidation reactor according to a comparative example.

The PROX device of the comparative example is used to represent characteristics of the PROX device of the embodiment more clearly. Except that the separation layer and the second catalyst are not provided, the PROX device of the comparative example has substantially the same structure and shape as the PROX device of FIG. 3. Further, the PROX device of the comparative device may correspond to example No. 02 of Table 1.

Referring to FIG. 4, the PROX device 50b of the comparative example has a granule-type catalyst 63 charged in the internal space 52 of the housing 51b. In a case where the catalyst 63 is a granule-type platinum-based catalyst, the catalyst 63 corresponds to the first catalyst of the embodiment.

When the catalyst 63 is a platinum-based catalyst, the PROX device 50b may be self-ignited. However, when only a platinum-based catalyst is used as the catalyst 63, the content of carbon monoxide in hydrogen mixed gas containing carbon monoxide of approximately 0.5 to 1% cannot he decreased to the range of dozens of ppm. When the hydrogen mixed gas containing carbon monoxide in the range of dozens of ppm is used for the fuel cell, the electrode of the fuel cell is poisoned by carbon monoxide and thus, activation thereof is remarkably decreased. As such, the hydrogen mixed gas produced from the PROX device 50b of the comparative example is not suitable to be used in a fuel cell.

On the other hand, the catalyst 63 may be a granule-type non-metal catalyst. In this case, the catalyst 63 may correspond to the second catalyst of the embodiment. When the catalyst 63 is the non-metal catalyst, the PROX device 50b is not self-ignited. Therefore, there is a disadvantage in that an additional ignition device should be additionally installed.

Further, the internal pressure of the PROX device Sob charged with the platinum-based catalyst 63 is approximately 5 kPa. The internal pressure is much higher than the internal pressure of the PROX device which is approximately 0.2 kPa, and the internal pressure of the PROX device shown in FIG. 3 which is approximately 1.0 kPa. When the internal pressure of the PROX device is high, the shift rate of carbon monoxide is decreased by limiting smooth flow of the hydrogen mixed gas in the device. Moreover, in the fuel reforming system, since an increase in the output of the components supplying fuel, steam, and air is required, the efficiency of the fuel reforming system or the PROX device may be deteriorated.

The internal pressure of the PROX device of the comparative example is higher than the internal pressure of the PROX device of the embodiment shown in FIG. 3 because the granule-type platinum-based catalyst (corresponding to first catalyst) having the smaller size than the second catalyst are charged in the internal space having the same volume.

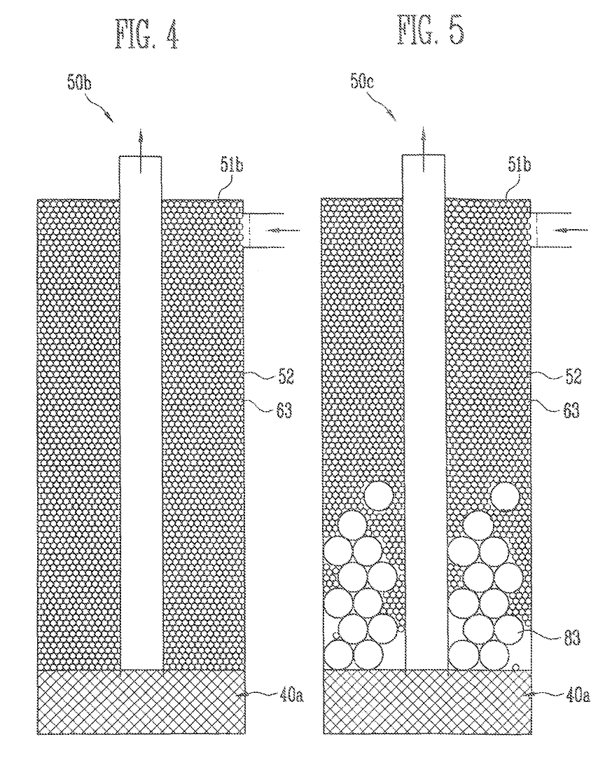

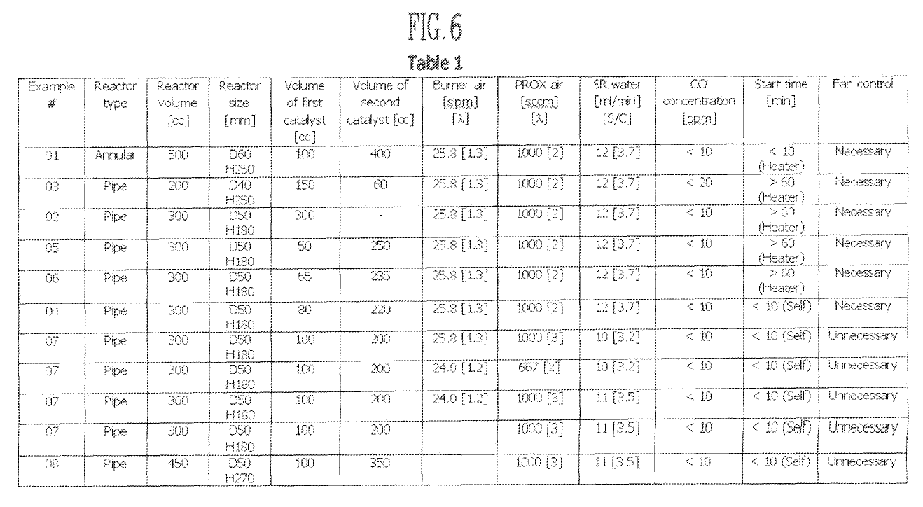

FIG. 5 is a schematic cross-sectional view for describing a preferential oxidation reactor according to another comparative example.

The PROX device of the comparative example is used to represent characteristics of the PROX device of the embodiment more clearly. Except that the separation layer is not provided, (which provides that the first catalyst and the second catalyst are not mixed in a partial area), the PROX device of the comparative example has substantially the same structure and shape as the PROX device of FIG. 3.

Referring to FIG. 5, the PROX device 50cb of the comparative example includes a granule-type first catalyst 63 and a granule-type second catalyst 83 which is larger than the first catalyst 63, that are charged in the internal space 52 of the housing 51b. The granule-type first and second catalysts 63 and 83 correspond to the first and second catalysts of the PROX device shown in FIG. 3.

When the second catalyst 83 is partially charged in the internal space 52 of the housing 51b and thereafter, the first catalyst 63 is charged the upper part of the internal space 52, and the separation layer is not provided, such that the granule-type first catalyst 63 is inserted between the granule-type second catalysts 83, which are larger than the first catalyst 63. Therefore, the internal pressure of the PROX device 50c reaches approximately 12 kPa. That is, when the granule-type platinum-based first catalyst 63 and the granule-type non-metal second catalyst 83, larger than the first catalyst, are sequentially charged in the internal space 52 of the housing 51b without the separation layer, the internal pressure is too large, and it is difficult to use them.

According to another embodiment, in the case of using the granule-type platinum-based first catalyst 63 and the granule-type non-metal second catalyst 83 having substantially the same size as the first catalyst 63, the internal pressure of the device is undesirably increased similarly to the case shown in FIG. 4. Further, in the above-mentioned case, it is difficult for the catalyst to be self-ignited.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and-equivalents thereof.

What is claimed is:

1. A preferential oxidation reactor, comprising:
a first reaction unit including a first internal space, to be supplied with mixed hydrogen gas, connected with a first opening portion, and a first catalyst capable of spontaneously igniting hydrogen mixed gas at a predetermined temperature of the first internal space;
a second reaction unit ding a second internal space connected to a second opening portion and a second catalyst contained in the second internal space; and
a separation layer positioned between the first and second catalysts to separate the first catalyst and the second catalyst, and which connects the first internal space and the second internal space to be in fluid communication.

2. The preferential oxidation reactor of claim 1, wherein the entire volume of the first catalyst is 0.004 times or more the flow rate per minute of hydrogen mixed gas supplied to the first internal space.

3. The preferential oxidation reactor of claim I, wherein the first catalyst contains platinum.

4. The preferential oxidation reactor of claim 3, wherein the first catalyst further contains palladium (Pd), rhenium (Re), rhodium (Rh), cerium (Ce), ruthenium (Ru), or iridium (Ir), or a combination thereof.

5. The preferential oxidation reactor of claim 4, wherein the first catalyst contains a ceramic carrier, a metallic carrier, or a carbon carrier, that have a granule shape, or a combination thereof.

6. The preferential oxidation reactor of claim 5, wherein the second catalyst includes a granule-type carrier larger than the carrier of the first catalyst.

7. The preferential oxidation reactor of claim 6, wherein the second catalyst includes a non-metal.

8. The preferential oxidation reactor of claim 7, wherein the second catalyst contains copper (Cu), iron (Fe), cobalt (Co), cerium (Ce), aluminum (Al), or an oxide thereof, or a combination thereof.

9. The preferential oxidation reactor of claim 6, wherein the second catalyst contains a ceramic carrier, a metallic carrier, or a carbon carrier, or a combination thereof.

10. The preferential oxidation reactor of claim 1, wherein the entire volume of the first catalyst is smaller than the entire volume of the second catalyst.

11. The preferential oxidation reactor of claim 1, wherein the separation layer includes a porous plate member.

12. The preferential oxidation reactor of claim 1, wherein the second reaction unit is positioned lower than the first reaction unit in the direction of gravtional force field lines.

13. The preferential oxidation reactor of claim 12, further comprising:
a water receiving unit lower than the first reaction unit in the direction of gravitational force field lines.

14. The preferential oxidation reactor of claim 13, wherein the second opening portion is positioned in an upper part of the water receiving unit in the direction of gravitational force field lines.

15. The preferential oxidation reactor of claim 14, further comprising:
a discharge unit that connects the water receiving unit and the second opening portion to each other to he in fluid communication.

16. The preferential oxidation reactor of claim 15, wherein the first reaction unit, the second reaction unit, and the discharge unit have a dual-pipe structure.
